(19) United States
(12) Patent Application Publication
(10) Pub. No.: US 2021/0282614 A1
(43) Pub. Date: Sep. 16, 2021

(54) SELF-PROPELLED VACUUM CLEANER

(71) Applicant: PANASONIC INTELLECTUAL PROPERTY MANAGEMENT CO., LTD, Osaka (JP)

(72) Inventors: Masahiro KAWAI, Shiga (JP); Yoshifumi KORI, Kyoto (JP)

(21) Appl. No.: 17/258,714

(22) PCT Filed: Jun. 21, 2019
(86) PCT No.: PCT/JP2019/024665

§ 371 Date: Jan. 7, 2021

(30) Foreign Application Priority Data
Jul. 20, 2018 (JP) 2018-137018

(51) Int. Cl. A47L 9/28; A47L 9/00; G05D 1/02

(52) U.S. Cl. CPC A47L 9/2852; A47L 9/009; G05D 2201/0215; G05D 1/0214; A47L 2201/04; A47L 9/2826

(57) ABSTRACT

Provided is a self-propelled vacuum cleaner including: a main body including a pair of wheels on left and right sides, main body moving on a floor surface to clean the floor surface; a drive unit that moves or turns the main body; a step detector (a collision sensor, an obstacle sensor, a ranging sensor, and a camera) that detects a step; and a controller that controls a moving unit based on a detection result of the step detector. The controller controls the drive unit to cause the main body to move by selecting a first route on which the step exists in front of both of the wheels, or a second route on which no step exists any of the wheels, when the step exists only in front of one of the pair of wheels. This provides the self-propelled vacuum cleaner capable of increasing reliability of cleaning on the floor surface.

### TECHNICAL FIELD

The present invention relates to a self-propelled vacuum cleaner that performs cleaning while running autonomously.

### BACKGROUND ART

There is conventionally known a self-propelled vacuum cleaner that cleans the floor surface while running autonomously (e.g., refer to PTL 1).

The self-propelled vacuum cleaner may run on a rug such as a carpet and run on the rug to clean the rug. At this time, it is assumed that only one of a pair of left and right wheels of the self-propelled vacuum cleaner runs on the rug for cleaning. This case causes a main body of the self-propelled vacuum cleaner to tilt, so that a distance from a suction port provided in the main body to a floor surface increases. Thus, normal suction force cannot be exerted, so that cleaning performance on the floor surface may deteriorate.

### CITATION LIST

### Patent Literature

PTL 1: Japanese Patent No. 4277214

### SUMMARY OF THE INVENTION

The present invention provides a self-propelled vacuum cleaner capable of reducing deterioration in cleaning performance in a cleaning area.

The self-propelled vacuum cleaner of the present invention includes a main body that is provided with a pair of wheels on left and right sides and that moves on a floor surface to clean the floor surface, a moving unit that is provided on the main body and moves or turns the main body a step detector provided on the main body and detecting a step existing around the main body and a controller that controls the moving unit based on a detection result of the step detector. The controller controls the moving unit to cause the main body to move by selecting a first route on which the step exists in front of each of the pair of wheels, or a second route on which no step exists in front of each of the pair of wheels, when the step detector detects that the step exists only in front of one of the pair of wheels.

Implementing a program for causing a computer to execute each process of the self-propelled vacuum cleaner also corresponds to implementation of the present invention. As a matter of route, implementing the program using a recording medium on which the program is recorded also corresponds to the implementation of the present invention.

The present invention enables providing a self-propelled vacuum cleaner capable of increasing reliability of cleaning in a cleaning area.

### BRIEF DESCRIPTION OF DRAWINGS

FIG. 1 is a plan view illustrating an appearance of a self-propelled vacuum cleaner according to an exemplary embodiment from above.

FIG. 2 is a bottom view illustrating the appearance of the self-propelled vacuum cleaner from below.

FIG. 3 is a perspective view illustrating the appearance of the self-propelled vacuum cleaner from diagonally above.

FIG. 4 is a schematic sectional view illustrating a schematic structure of a lifter of the self-propelled vacuum cleaner.

FIG. 5 is a block diagram illustrating a control configuration of the self-propelled vacuum cleaner.

FIG. 6 is an explanatory diagram illustrating operation of self-propelled vacuum cleaner 100 according to an exemplary embodiment when a step exists in front of each of a pair of wheels.

FIG. 7 is an explanatory diagram illustrating an example in which a first route is selected when a step exists only in front of one of the pair of wheels of the self-propelled vacuum cleaner.

FIG. 8 is a flowchart illustrating operation of the self-propelled vacuum cleaner for the step, according to the exemplary embodiment.

FIG. 9 is a front view illustrating a state in which only one wheel of the self-propelled vacuum cleaner has run on the step.

FIG. 10 is an explanatory diagram illustrating an example in which a second route is selected when the step exists only in front of one of the pair of wheels of the self-propelled vacuum cleaner.

FIG. 11 is an explanatory diagram illustrating an example in which the self-propelled vacuum cleaner selects the second route based on a previous path.

FIG. 12 is an explanatory diagram illustrating an example in which the self-propelled vacuum cleaner selects the first route based on the previous path.

### DESCRIPTION OF EMBODIMENT

Hereinafter, a self-propelled vacuum cleaner according to an exemplary embodiment of the present invention will be described with reference to the drawings. The following exemplary embodiment is merely an example of the self-propelled vacuum cleaner in the present invention. Thus, the present invention is defined by the wording of the scope of claims with reference to the following exemplary embodiment, and is not limited to the following exemplary embodiment. Although components in the following exemplary embodiment includes a component that is not described in the independent claim showing the highest concept of the present invention and that is not necessarily required to achieve an object of the present invention, the component is described to constitute a more preferable form.

The drawings are each a schematic view in which a component is appropriately emphasized, eliminated, and adjusted in ratio to illustrate the present invention, and may be different in shape, positional relationship, and ratio from an actual component.

### Exemplary Embodiment

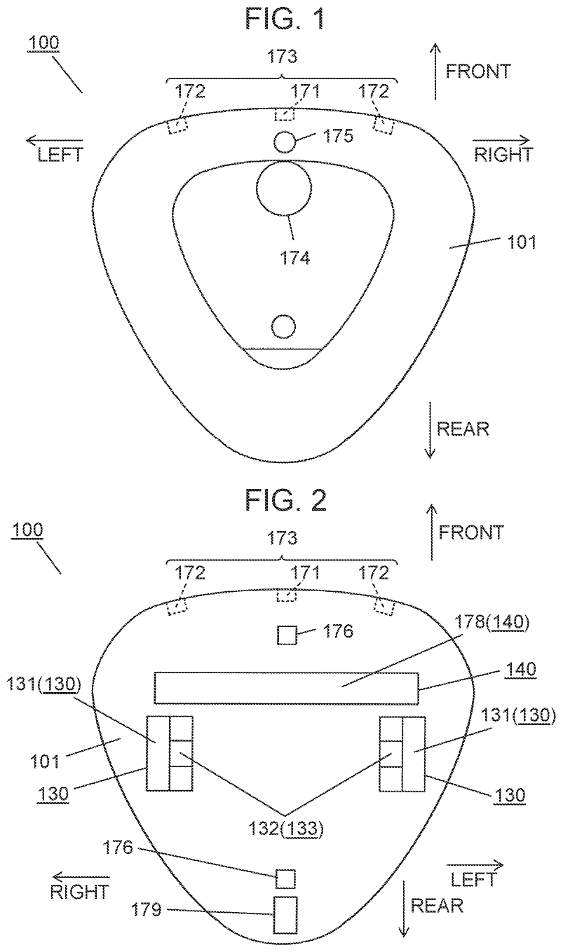

Hereinafter, self-propelled vacuum cleaner 100 according to an exemplary embodiment of the present invention will be described with reference to FIGS. 1 to 3.

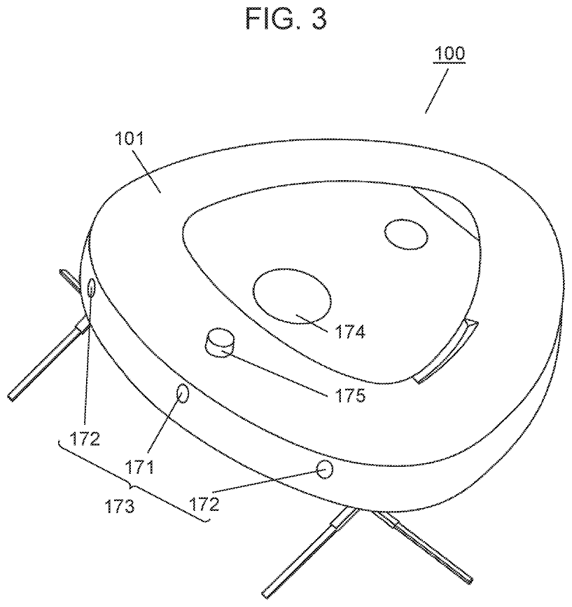

FIG. 1 is a plan view illustrating an appearance of self-propelled vacuum cleaner 100 according to the present exemplary embodiment from above. FIG. 2 is a bottom view illustrating the appearance of self-propelled vacuum cleaner 100 from below. FIG. 3 is a perspective view illustrating the appearance of self-propelled vacuum cleaner 100 from diagonally above.

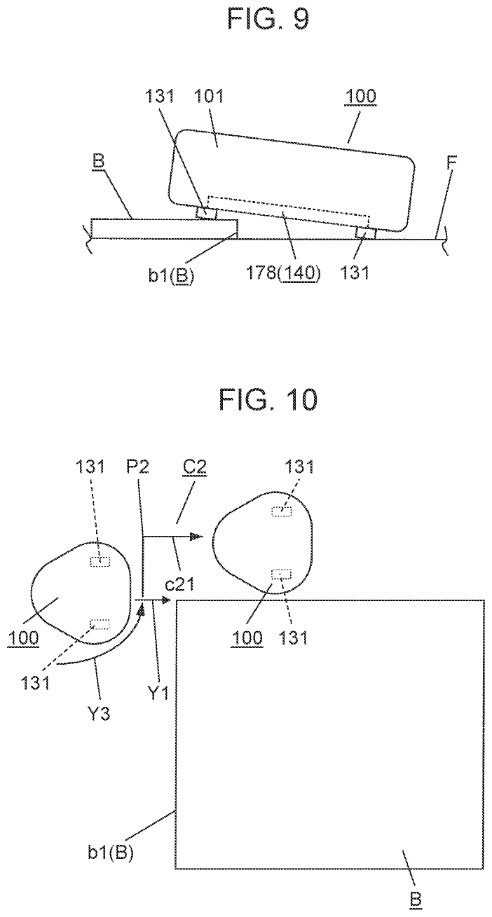

Self-propelled vacuum cleaner 100 is a cleaning robot that performs cleaning while autonomously moving on a cleaning area such as floor surface F (refer to FIG. 9). Specifically, self-propelled vacuum cleaner 100 is a robot vacuum cleaner that autonomously runs in a predetermined cleaning area based on an environmental map described later and sucks dust existing in the cleaning area.

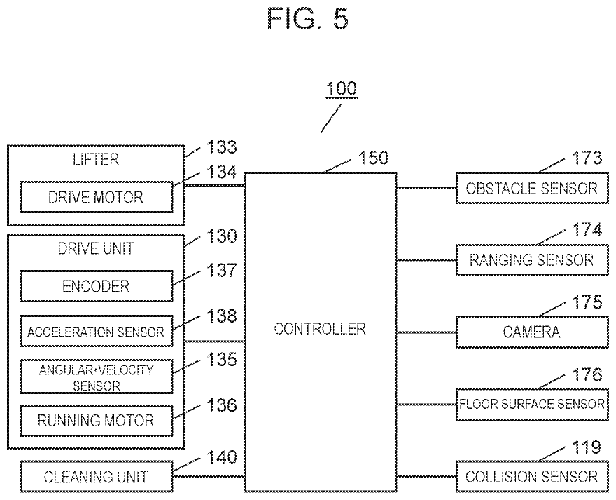

As illustrated in FIGS. 1 to 3, self-propelled vacuum cleaner 100 of the present exemplary embodiment includes main body 101, a pair of drive units 130, cleaning unit 140 having suction port 178, various sensors described later, controller 150 (refer to FIG. 5), lifter 133, and the like. Main body 101 constitutes an outer shell of self-propelled vacuum cleaner 100 that moves on a cleaning area such as floor surface F and cleans the cleaning area. Cleaning unit 140 sucks dust existing in the cleaning area from suction port 178. A placement relationship is subsequently described, for example, as illustrated in FIG. 1 such that a side on which obstacle sensor 173 described later is disposed is defined as the front, an opposite side is defined as the rear, a right side when facing the front is defined as the right, and a left side when facing the front is defined as the left.

As illustrated in FIG. 2, one drive unit 130 is disposed on each left and right side with respect to the center in a width direction in the left-right direction in plan view of self-propelled vacuum cleaner 100. A number of drive units 130 is not limited to two (pair), and may be one, or three or more.

Each of drive units 130 according to the present exemplary embodiment includes wheel 131 that runs on floor surface F, running motor 136 (refer to FIG. 5) that applies torque to wheel 131, a housing that accommodates running motor 136, and the like. Each of wheels 131 is housed in a recess (not illustrated) formed in a lower surface of main body 101, and is rotatably attached to main body 101.

Self-propelled vacuum cleaner 100 further includes caster 179 as an auxiliary wheel to form an opposed two-wheel type. When rotation of each of wheels 131 of the pair of drive units 130 is independently controlled, self-propelled vacuum cleaner 100 can freely run forward, backward, counterclockwise, clockwise, and the like. Specifically when each of wheels 131 of the pair of drive units 130 is rotated counterclockwise or clockwise while moving forward and backward, self-propelled vacuum cleaner 100 turns right or left when moving forward or backward. In contrast, when each of wheels 131 of the pair of drive units 130 is rotated counterclockwise or clockwise without moving forward or backward, self-propelled vacuum cleaner 100 turns on at the current point. That is, drive unit 130 functions as a moving unit for moving or turning main body 101 of self-propelled vacuum cleaner 100. Then, drive units 130 cause self-propelled vacuum cleaner 100 to run in a cleaning area such as floor surface F based on an instruction from controller 150.

Cleaning unit 140 constitutes a unit that collects dust and sucks the dust from suction port 178. Cleaning unit 140 includes a main brush disposed in suction port 178, a brush drive motor for rotating the main brush, and the like. Then, cleaning unit 140 causes a brush drive motor or the like to operate based on an instruction from controller 150.

A suction device (not illustrated) that sucks dust from suction port 178 is disposed inside main body 101. The suction device includes a fan case and an electric fan disposed inside the fan case (not illustrated). Then, the suction device causes the electric fan or the like to operate based on an instruction from controller 150.

Self-propelled vacuum cleaner 100 further includes various sensors exemplified below, such as obstacle sensor 173, ranging sensor 174, collision sensor 119 (refer to FIG. 5), camera 175, floor surface sensor 176, acceleration sensor 138 (refer to FIG. 5), and angular velocity sensor 135 (refer to FIG. 5).

Obstacle sensor 173 detects an obstacle existing in front of main body 101. The present exemplary embodiment uses an ultrasonic sensor as obstacle sensor 173, for example. Obstacle sensor 173 is composed of, for example, one transmitter 171 and two receivers 172. Transmitter 171 is disposed at the center of the front of main body 101, and transmits ultrasonic waves forward, Receivers 172 are disposed on both sides of transmitter 171 and receive the ultrasonic waves transmitted from transmitter 171. That is, obstacle sensor 173 is configured to allow receiver 172 to receive ultrasonic waves that are transmitted from transmitter 171 and returned by being reflected by an obstacle. This allows obstacle sensor 173 to detect a distance between main body 101 and the obstacle, and a position of main body 101.

Ranging sensor 174 detects a distance between an object such as an obstacle existing around self-propelled vacuum cleaner 100 and self-propelled vacuum cleaner 100. The present exemplary embodiment includes ranging sensor 174 that is composed of, for example, a so-called laser range scanner that scans with a laser beam and measures a distance based on light reflected from an obstacle.

Collision sensor 119 is composed of, for example, a switch contact displacement sensor, and is provided on a bumper or the like disposed around main body 101 of self-propelled vacuum cleaner 100. The switch contact displacement sensor is turned on when an obstacle comes into contact with the bumper and the bumper is pushed against self-propelled vacuum cleaner 100. This allows collision sensor 119 to detect contact with an obstacle.

Camera 175 is a device that images a space in front of main body 101. An image captured by camera 175 is subjected to image processing. This processing allows a shape of an obstacle, for example, in a space in front of main body 101 to be recognized from a position of a feature point in the image.

That is, obstacle sensor 173, ranging sensor 174, and camera 175, which are described above, function as an obstacle detector that detects an obstacle existing around main body 101.

As illustrated in FIG. 2, floor surface sensor 176 is disposed at a plurality of locations on a bottom surface of main body 101 of self-propelled vacuum cleaner 100, and detects whether a cleaning area such as floor surface F exists. The present exemplary embodiment includes floor surface sensor 176 that is composed of, for example, an infrared sensor having a light emitter and a light receiver. That is, when light (infrared ray) radiated from the light emitter returns and is received by the light receiver, floor surface sensor 176 determines the state as “with floor surface F”. In contrast, when the light receiver receives only Light below a threshold value, floor surface sensor 176 determines the state as “no floor surface F”.

Drive units 130 each further include encoder 137, as illustrated in FIG. 5. Encoder 137 detects a rotation angle of each of the pair of wheels 131 rotated by the corresponding one of running motors 136. Based on information from encoder 137, controller 150 calculates, for example, the amount of running, a turning angle, a speed, acceleration, angular velocity, and the like of self-propelled vacuum cleaner 100.

As illustrated in FIG. 5, drive units 130 each further include acceleration sensor 138, angular velocity sensor 135, and the like. Acceleration sensor 138 detects acceleration when self-propelled vacuum cleaner 100 runs. Angular velocity sensor 135 detects angular velocity when self-propelled vacuum cleaner 100 turns. Information detected by acceleration sensor 138 and angular velocity sensor 135 is used for information to correct an error (e.g., deviation between operation instructions such as movement and turning issued by the controller and actual operation results) caused by for example, racing of wheels 131.

Obstacle sensor 173, ranging sensor 174, the collision sensor, camera 175, floor surface sensor 176, the encoder, and the like, which are described above, are examples of sensors. Thus, self-propelled vacuum cleaner 100 of the present exemplary embodiment may be provided with other different types of sensor, such as a dust sensor, a motion sensor, and a charging-stand-position detection sensor, in addition to the above, if necessary.

Self-propelled vacuum cleaner 100 further includes lifter 133. Lifter 133 constitutes a device for lifting at least a part of main body 101.

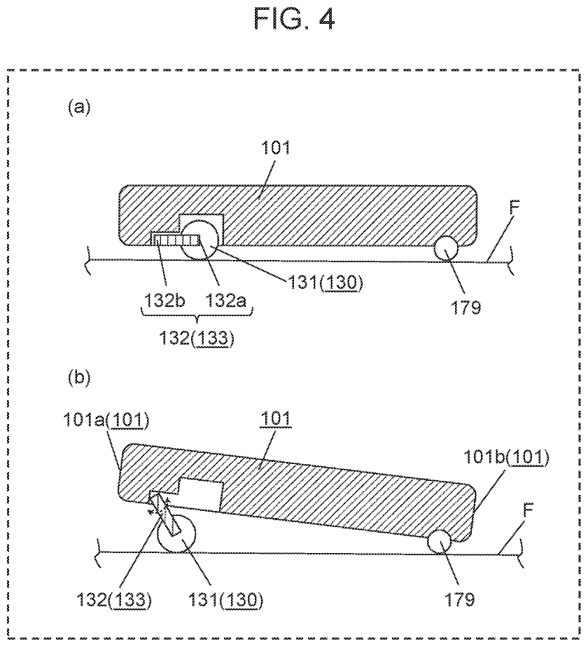

Hereinafter, lifter 133 of self-propelled vacuum cleaner 100 will be described with reference to FIG. 4.

FIG. 4 is a schematic sectional view illustrating a schematic structure of lifter 133 of self-propelled vacuum cleaner 100. Part (a) of FIG. 4 illustrates a state in which lifting of main body 101 is released by lifter 133 (hereinafter, referred to as a “normal state”). Part (b) of FIG. 4 illustrates a state in which main body 101 is lifted by lifter 133 (hereinafter referred to as a “lifted state”).

Lifter 133 is incorporated in drive unit 130 as illustrated in FIGS. 1 and 4. Specifically, lifter 133 includes arm 132, drive motor 134 (refer to FIG. 5), and the like. Arm 132 rotatably holds wheel 131 of drive unit 130 in leading end portion 132a. Drive motor 134 rotates base end portion 132b of arm 132. This causes leading end portion 132a of arm 132 to appear and disappear from main body 101.

When leading end portion 132a of arm 132 is housed in main body 101 as illustrated in part (a) of FIG. 4, an installation state of main body 101 is in the normal state. That is, when main body 101 is in the normal state, the various sensors described above do not, for example, turn up. For example, when main body 101 is in the lifted state, the obstacle sensor has a detection direction directed upward. Thus, low obstacles scattering on a floor surface cannot be detected, so that there is a risk of collision with the obstacles. However, setting main body 101 to the normal state enables an obstacle to be reliably detected, so that collision can be avoided. This enables various detections required for cleaning to be accurately performed using the various sensors.

In contrast, when leading end portion 132a of arm 132 projects downward from main body 101 (toward floor surface F) as illustrated in part (b) of FIG. 4, main body 101 is in the lifted state. That is, front portion 101a of main body 101 is lifted above rear portion 101b with respect to floor surface F. This causes main body 101 to be in a tilted state in which front portion 101a is higher than rear portion 101b with respect to floor surface F.

That is, lifter 133 lifts front portion 101a of main body 101 according to a situation of surrounding obstacles. Lifter 133 functions to enables helping main body 101 to run on an obstacle during forward operation without colliding with the obstacle. For example, when the obstacle is a rug such as a carpet, main body 101 being not in the lifted state may come into contact with the rug and roll up the rug. When the rug is rolled up, main body 101 comes into contact with a rolled-up portion and is hindered from running further forward. Specifically, the collision sensor or the like reacts due to the contact to cause main body 101 to perform an avoidance operation, so that main body 101 is hindered from running forward. Further, when main body 101 runs into, or slips into the rolled-up rug, cleaning on the rug cannot be performed. When these conditions occur, cleaning performance of self-propelled vacuum cleaner 100 for the rug is deteriorated. Thus, self-propelled vacuum cleaner 100 of the present exemplary embodiment is configured such that when the obstacle detector detects a rug such as a carpet, lifter 133 is driven to bring main body 101 into the lifted state. This enables main body 101 to easily run on the rug. Thus, interference between main body 101 and the rug is less likely to occur. As a result, self-propelled vacuum cleaner 100 can achieve stable cleaning performance on the rug.

As described above, self-propelled vacuum cleaner 100 of the present exemplary embodiment is configured and operates.

Hereinafter, a control configuration of self-propelled vacuum cleaner 100 having the above configuration will be described with reference to FIG. 5.

FIG. 5 is a block diagram illustrating the control configuration of self-propelled vacuum cleaner 100 of the exemplary embodiment.

As illustrated in FIG. 5, controller 150 is electrically connected to drive unit 130, obstacle sensor 173, ranging sensor 174, camera 175, floor surface sensor 176, collision sensor 119, cleaning unit 140, lifter 183, and the like. Although FIG. 5 illustrates only one drive unit 130, drive unit 130 is actually provided corresponding to each of left and right wheels 131. That is, self-propelled vacuum cleaner 100 of the present exemplary embodiment has two drive units 130.

Controller 150 includes, for example, a central processing unit (CPU), a random access memory (RAM), a read only memory (ROM), and the like. Controller 150 controls operation of each of the above-mentioned connected units by allowing the CPU to expand a program stored in the ROM into the RAM and execute the program.

Next, control operation of controller 150 will be described. Controller 150 accumulates data detected by the various sensors described above. Then, controller 150 integrates the accumulated data to create an environmental map. Here, the environmental map is a map of an area where self-propelled vacuum cleaner 100 moves within a predetermined cleaning area and performs cleaning. Although a method for creating the environmental map is not particularly limited, examples thereof include simultaneous localization and mapping (SLAM).

Specifically, controller 150 creates the environmental map by forming information based on a running history of self-propelled vacuum cleaner 100, the information indicating an outer shape of a cleaning area where self-propelled. vacuum cleaner 100 has actually run and placement of obstacles that hinders running. The environment map is created as, for example, two-dimensional array data. At this time, controller 150 may process the running history as array data by dividing the running history into quadrangles each having a predetermined size such as 10 cm in length and width, and regarding each of the quadrangles as an element area of an array constituting the environment map. The environmental map may be obtained from a device or the like provided outside self-propelled vacuum cleaner 100.

Controller 150 records a running path during cleaning using each coordinate in the environment map during running of self-propelled vacuum cleaner 100. Specifically, controller 150 detects each coordinate in the environmental map of self-propelled vacuum cleaner 100 based on data detected by the various sensors during cleaning, and records each coordinate as the running path.

Controller 150 further controls cleaning unit 140 and the suction device during cleaning. Specifically, controller 150 controls a brush drive motor of cleaning unit 140 and an electric fan of the suction device so that dust on floor surface F is sucked using suction force generated by the electric fan while a main brush of cleaning unit 140 is rotated.

Controller 150 further controls drive motor 134 of lifter 133 based on a detection result whether an obstacle exists acquired by the obstacle detector, thereby switching between the normal state and the lifted state of main body 101. Specifically, controller 150 determines a route of main body 101 after detection of the obstacle based on the detection result of the obstacle detector when at least one of obstacle sensor 173, ranging sensor 174, and camera 175, which constitute the obstacle detector, detects the obstacle.

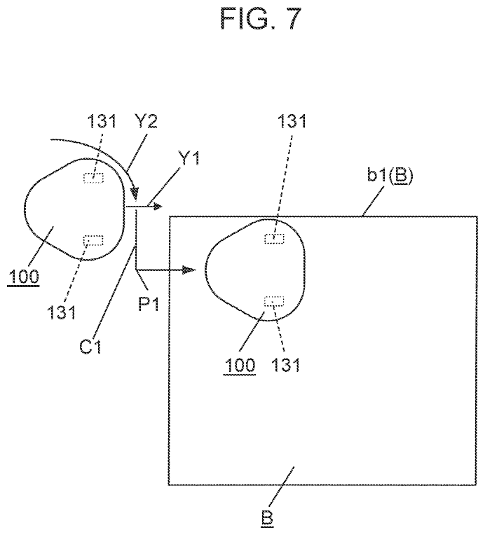

The obstacles described above are classified into an obstacle or step B (refer to FIG. 7 and the like) that self-propelled vacuum cleaner 100 can run over (run on) and an obstacle that self-propelled vacuum cleaner 100 cannot run over. Examples of the obstacle that can be run over include a rug such as a carpet. Examples of the obstacle that cannot be run over include a wall and furniture.

Then, controller 150 determines whether an obstacle can be run over or cannot be run over based on a detection result of collision sensor 119. Hereinafter, an obstacle that can be run over will be referred to as “step B”.

Specifically, controller 150 determines that an obstacle cannot be run over when collision sensor 119 indicates a detection result of ON while the obstacle detector detects the obstacle. In contrast, controller 150 determines that an obstacle is step B that can be run over when collision sensor 119 still indicates a detection result of OFF while the obstacle detector detects the obstacle.

That is, collision sensor 119, and obstacle sensor 173, ranging sensor 174, and camera 175 that constitute the obstacle detector, function as a step detector that detects step B existing around main body 101. When a thickness of the obstacle (height from floor surface F) can be detected from an image of the obstacle captured by camera 175, controller 150 may determine whether the obstacle is step B based on the detected thickness. When at least one of collision sensor 119, obstacle sensor 173, ranging sensor 174, and camera 175 can detect step B existing around main body 101, the at least one of them may constitute the step detector.

As described above, controller 150 controls each unit.

Hereinafter, control operation of controller 150 when step B is detected as an obstacle, for example, will be described.

First, controller 150 recognizes a shape (particularly a thickness), a size, a position, etc., of step B, based on an image of step B detected by camera 175 constituting the step detector, for example. Then, controller 150 determines whether step B exists in front of each of the pair of wheels 131 based on the recognized result. Controller 150 may determine whether step B exists in front of each of the pair of wheels 131 based on a detection result of the step detector other than camera 175.

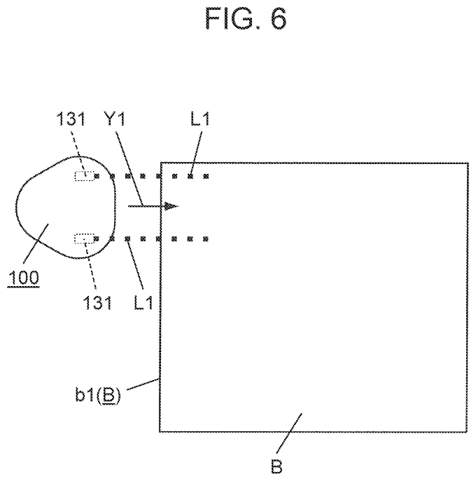

Next, control by controller 150 and operation of self-propelled vacuum cleaner 100 when step B is detected in front of each of the pair of wheels 131 will be described with reference to FIG. 6.

FIG. 6 is an explanatory diagram illustrating operation of self-propelled vacuum cleaner 100 according to the exemplary embodiment when step B exists in front of each of the pair of wheels 131. Here, examples of a state where step B exists in front of wheels 131 include a state where step B overlaps an extension line (refer to broken line L1 illustrated in FIG. 6) of each of wheels 131 in a traveling direction of main body 101. For example, the examples include a case where no step B exists near wheels 131 and step B exists at a distance (e.g., about 50 cm ahead).

First, when the step detector detects step B existing in front of each of the pair of wheels 131, controller 150 controls drive of drive unit 130 to maintain a current traveling direction (refer to arrow Y1 illustrated in FIG. 6). This causes main body 101 to enter step B still in the current traveling direction.

Next, controller 150 controls drive motor 134 of lifter 133 to lift main body 101 just before main body 101 enters (runs on) step B, and then main body 101 is brought into a lifted state as illustrated in part (b) of FIG. 4.

Next controller 150 subsequently controls running motor 136 of drive unit 130 to cause main body 101 to run on step B, while maintaining the traveling direction of main body 101. This causes main body 101 to run on step B.

After the whole of main body 101 runs on step B, controller 150 controls drive motor 134 of lifter 133 to release the lifted state of main body 101, and then main body 101 is returned to in the normal state as illustrated in part (a) of FIG. 4. This causes main body 101 to be brought into the normal state on step B. Thus, a distance between an upper surface of step B and suction port 178 of cleaning unit 140 becomes constant. As a result, self-propelled vacuum cleaner 100 can exert normal suction force to efficiently suck dust existing on step B, similar to floor surface F.

Next, control by controller 150 and operation of self-propelled vacuum cleaner 100 when step B is detected only in front of any one of the pair of wheels 131 will be described with reference to FIG. 7.

FIG. 7 is an explanatory diagram illustrating an example in which first route C1 is selected when step B exists only in front of one of the pair of wheels 131 according to the exemplary embodiment.

As illustrated in FIG. 7, when the step detector detects step B existing only in front of one of the pair of wheels 131, controller 150 first controls drive unit 130 to move main body 101 according to selected first route C1. Here, first route C1 corresponds to a path through which main body 101 is moved allowing step B to exist in front of each of the pair of wheels 131. Main body 101 changes in direction from the current traveling direction in this case, and then enters step B after moving through first route C1.

Specifically, controller 150 first causes main body 101 to be turned to the right, for example, by 90 degrees from the current traveling direction (refer to arrow Y1 illustrated in FIG. 7), and then main body 101 is changed in direction (refer to arrow Y2 illustrated in FIG. 7).

After main body 101 is changed in direction, controller 150 controls running motor 136 of drive unit 130 to cause main body 101 to move in first route C1 selected. Then, controller 150 causes main body 101 to turn by 90 degrees to the left, for example, at point P1 in first route C1. This brings main body 101 into a state where main body 101 directly faces step B and step B exists in front of each of the pair of wheels 131. As long as step B exists in front of each of the pair of wheels 131, main body 101 may not directly face step B. That is, main body 101 may have a traveling direction tilted from edge b1 of step B.

Next, controller 150 controls drive motor 134 of lifter 133 to lift main body 101 just before main body 101 enters (runs on) step B, and then main body 101 is brought into a lifted state (corresponding to part (b) of FIG. 4).

Controller 150 subsequently controls running motor 136 of drive unit 130 to cause main body 101 to run on step B according to first route C1. This causes main body 101 to run on step B.

After the whole of main body 101 runs on step B, controller 150 controls drive motor 134 of lifter 133 to release lifting of main body 101, and then main body 101 is returned to in the normal state (corresponding to part (a) of FIG. 4). This causes main body 101 to be brought into the normal state on step B. Thus, a distance between an upper surface of step B and suction port 178 of cleaning unit 140 becomes constant. As a result, self-propelled vacuum cleaner 100 can exert normal suction force to efficiently suck dust existing on step B, similar to floor surface F.

As described above, the control of controller 150 and the operation of self-propelled vacuum cleaner 100 are performed according to a detection state of step B with respect to the pair of wheels 131.

When a planned path of cleaning (a path through which main body 101 runs) is preliminarily registered in the above exemplary embodiment, controller 150 desirably updates the planned path by reflecting first route C1 on the planned path. When a planned path is not registered, controller 150 desirably controls drive unit 130 to allow first route C1 to be included in a subsequent running path of main body 101 based on detection results of the various sensors.

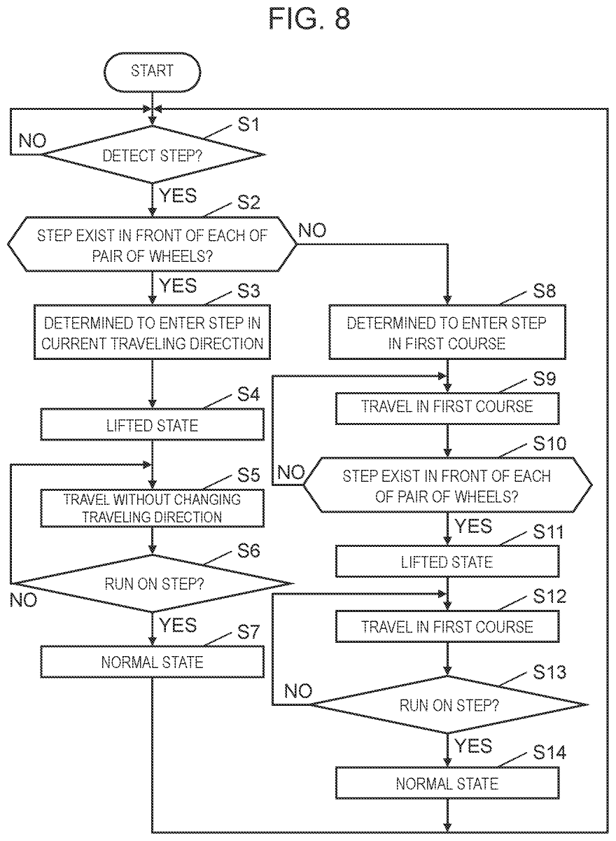

Hereinafter, one mode of operation for step B among operations of self-propelled vacuum cleaner 100 will be described below with reference to FIG. 8.

FIG. 8 is a flowchart illustrating operation of self-propelled vacuum cleaner 100 for step B, according to the exemplary embodiment. The flowchart illustrated in FIG. 8 shows a flow when cleaning is performed.

As illustrated in FIG. 8, when cleaning is started, controller 150 first determines whether the step detector detects step B while main body 101 moves in a predetermined route (step S1). At this time, when step B is not detected (NO in step S1), controller 150 continues cleaning in the same route.

In contrast, when step B is detected (YES in step S1), controller 150 determines whether step B exists in front of each of the pair of wheels 131 based on a detection result of the step detector (step S2). Here, controller 150 determines step B within a predetermined range in front of main body 101. The predetermined range is set for determining step B approaching main body 101, and is smaller, for example, than a total length of main body 101 in a front-rear direction.

At this time, when no step B exists in front of any one of the pair of wheels 131 (NO in step S2), controller 150 proceeds to step S8 described later.

In contrast, when step B exists in front of each of the pair of wheels 131 (YES in step S2), controller 150 determines to enter step B while maintaining the current traveling direction (step S3).

Then, controller 150 controls drive motor 134 of lifter 133 to lift main body 101 and bring main body 101 into the lifted state (step S4).

Next, controller 150 controls running motor 136 of drive unit 130 to cause main body 101 to run on step B, and causes main body 101 to travel without change in traveling direction (step S5).

Next controller 150 subsequently determines whether main body 101 has run on step B based on detection results of the various sensors (step S6). At this time, when main body 101 has not run on step B (NO in step S6), processing proceeds to step 55, and subsequent steps are repeated.

In contrast, when main body 101 has run on step B (YES in step S6), controller 150 controls drive motor 134 of lifter 133 to release lifting of main body 101 and return main body 101 to in the normal state (step S7). This enables main body 101 to exert normal suction force even on step B.

After that, controller 150 proceeds to step S1 and executes subsequent steps.

Here, when no step B exists in front of any one of the pair of wheels 131 described above (NO in step S2), controller 150 determines to cause main body 101 to enter step B according to first route C1 (step S8).

Then, controller 150 controls running motor 136 of drive unit 130 to cause main body 101 to travel according to first route C1 (step S9).

Next controller 150 subsequently determines whether step B exists in front of each of the pair of wheels 131 based on a detection result of the step detector (step S10). Here, controller 150 determines step B within a predetermined range in front of main body 101.

At this time, when no step B exists in front of one of the pair of wheels 131 (NO in step S10), controller 150 proceeds to step S9 and repeats subsequent steps.

In contrast, when step B exists in front of each of the pair of wheels 131 (YES in step S10), controller 150 controls drive motor 134 of lifter 133 to lift main body 101 and bring main body 101 into the lifted state (step S11). At this time, controller 150 desirably controls lifter 133 to lift main body 101 after temporarily stopping running in first route C1.

Next, after main body 101 is brought into the lifted state, controller 150 controls running motor 136 of drive unit 130 to cause main body 101 to travel in first route C1 and run on step B (step S12).

Next controller 150 subsequently determines whether the whole of main body 101 has run on step B based on detection results of the various sensors (step S13). At this time, when main body 101 has not run on step B (NO in step S13), processing proceeds to step S12, and subsequent steps are repeated.

In contrast, when main body 101 has run on step B (YES in step S13), controller 150 controls drive motor 134 of lifter 133 to release lifting of main body 101 and return main body 101 to in the normal state (step S14). This enables main body 101 to exert normal suction force even on step B.

After that, controller 150 proceeds to step S1 and executes subsequent steps.

As described above, self-propelled vacuum cleaner 100 of the present exemplary embodiment includes main body 101 that has the pair of left and right wheels 131 to move on floor surface F to clean floor surface F, and the moving unit (drive unit 130) that is provided in main body 101 to move or turn main body 101. Self-propelled vacuum cleaner 100 further includes the step detector (collision sensor 119, obstacle sensor 173, ranging sensor 174, and camera 175) that is provided in main body 101 to detect step B existing around. main body 101, and controller 150 that controls the moving unit based on a detection result of the step detector. When the step detector detects that step B exists only in front of one of the pair of wheels 131, controller 150 selects first route C1 to allow step B to exist in front of each of the pair of wheels 131 and controls the moving unit to cause the main body to move based on first route C1.

Here, a state of main body 101 in which only one of the pair of wheels 131 of self-propelled vacuum cleaner 100 has run on step B will be described with reference to FIG. 9.

FIG. 9 is a front view illustrating a state in which only one of the pair of wheels 131 of self-propelled vacuum cleaner 100 has run on step B.

As illustrated in FIG. 9, when only one of wheels 131 has run on step B, a right side, for example, of main body 101 of self-propelled vacuum cleaner 100 is tilted from floor surface F. Thus, suction port 178 of cleaning unit 140 is also disposed at an angle from floor surface F. This causes a distance between suction port 178 and floor surface F to be partially increased. In particular, a distance between suction port 178 and floor surface F increases at edge b1 around step B. In a portion having a large distance between suction port 178 and floor surface F, main body 101 cannot exert normal suction force in the normal state. As a result, the cleaning performance of self-propelled vacuum cleaner 100 is deteriorated.

The above exemplary embodiment is, however, configured such that when step B exists only in front of one of the pair of wheels 131, main body 101 is moved according to first route C1 to allow step B to exist in front of each of the pair of wheels 131. Thus, for step B, both of the pair of wheels 131 run on step B. That is, a state in which only one of wheels 131 runs on step B as illustrated in FIG. 9 can be avoided. This enables self-propelled vacuum cleaner 100 of the exemplary embodiment to be reduced in deterioration in cleaning performance for floor surface F.

FIG. 9 illustrates a run-on state where one of wheels 131 is on floor surface F, and another wheel 131 is on a surface of step B. That is, each of the pair of wheels 131 comes into contact with a surface different in state and material, so that a difference in friction may occur. When there is a difference in friction between the pair of wheels 131, transmission force (torque) to a contact surface will be different, and thus main body 101 is less likely to be run in an intended path. However, the above exemplary embodiment enables avoiding a state in which only one of wheels 131 has run on step B by moving main body 101 according to first route C1. This causes friction between the pair of wheels 131 to be less likely to differ. As a result, run control of main body 101 is improved in accuracy, so that main body 101 can be run in an intended path.

Self-propelled vacuum cleaner 100 of the present exemplary embodiment further includes lifter 133 that is provided on main body 101 to lift main body 101 from floor surface F. Lifter 133 can bring main body 101 into the lifted state or the normal state according to a situation. Then, the lifted state allows main body 101 to easily run on step B. This causes interference, such as contact between main body 101 and step B or slipping of main body 101 into step B, to be less likely to occur. As a result, stable cleaning performance can be achieved for step B.

The present invention is not limited to the above exemplary embodiment. For example, exemplary embodiments of the present invention may include another exemplary embodiment configured by appropriately combining components described in the present specification or excluding some of the components. The present invention also includes modifications obtained by making various modifications that can be conceived by those skilled in the art without departing from the scope of the gist of the present invention, i.e., the meaning indicated by the words described in the scope of claims.

For example, although the above exemplary embodiment describes an example in which controller 150 selects first route C1 and controls the moving unit for operation when the step detector detects that step B exists only in front of one of the pair of wheels 131, the present invention is not limited to this. Controller 150, for example, may select second route C2 in which no step B exists in front of one of the pair of wheels 131, and control the moving unit (drive unit 130) to move main body 101, as illustrated in FIG. 10.

FIG. 10 is an explanatory diagram illustrating an example of moving in second route C2 when step B exists only in front of one of the pair of wheels 131.

As illustrated in FIG. 10, when the step detector detects that step B exists only in front of one of the pair of wheels 131, controller 150 controls drive unit 130 for operation by taking second route C2 in which no step B exists in front of each of the pair of wheels 131. In this case, main body 101 changes in direction from the current traveling direction and travels in second route C2. Thus, main body 101 does not enter step B.

Specifically, controller 150 first causes main body 101 to be turned to the left, for example, by 90 degrees from the current traveling direction (refer to arrow Y1 illustrated in FIG. 10), and then main body 101 is changed in direction (refer to arrow Y3 illustrated in FIG. 10).

After main body 101 is changed in direction, controller 150 controls running motor 136 of drive unit 130 to cause main body 101 to move by taking second route C2. Then, at point P2 in second route C2, controller 150 turns main body 101 by 90 degrees to the right, for example. This avoids step B, and brings about a state where no step B in front of each of the pair of wheels 131 of main body 101.

After that, controller 150 allows second route C2 to include path c21 along a boundary between step B and floor surface F. Path c21 is downstream of point P2 in second route C2. Path c21 is substantially parallel (including parallel) to the boundary between step B and floor surface F, i.e., edge b1 of step B. This allows main body 101 to travel (move) along path c21. As a result, self-propelled vacuum cleaner 100 can reliably clean the periphery of step B while moving along edge b1 of step B.

That is, when step B exists only in front of one of the pair of wheels 131, main body 101 is moved in second route C2 in which no step B exists in front of each of the pair of wheels 131. This enables preventing main body 101 from moving while only one of wheels 131 has run on step B. That is, this enables reducing a frequency of a state in which although the wheels of main body 101 do not run on step B, for example, main body 101 has an end having run on step B and tilts slightly from floor surface F. As a result, deterioration in cleaning performance due to main body 101 tilting from floor surface F can be reduced.

During traveling of main body 101 along second route C2, when main body 101 interferes with step B a state where main body 101 runs with its end rubbing on step B) even with the pair of wheels 131 being not on the surface of step B, main body 101 may tilt from floor surface F, or deteriorate in running performance. In this case, controller 150 may control the moving unit to cause main body 101 to move by taking second route C2 in which main body 101 does not interfere with step B. This can reduce the above concerns.

When a planned path of cleaning is preliminarily registered, controller 150 may update the planned path by reflecting second route C2 on the planned path. In contrast, when a planned path is not registered, controller 150 may cause main body 101 to move by controlling drive unit 130 to allow second route C2 to be included in a subsequent running path of main body 101 based on detection results of the various sensors.

Controller 150 may be configured to select any one of first route C1 and second route C2 when the step detector detects that step B exists only in front of one of the pair of wheels 131.

Specifically controller 150 selects first route C1 or second route C2 such that the whole of the environmental map described above can be cleaned efficiently and reliably. Controller 150 normally controls drive of drive unit 130 to fill the whole of the environment map with running paths of main body 101. At this time, controller 150 desirably selects first route C1 or second route C2 such that main body 101 cleans the same part in the environmental map as few times as possible. Besides this, controller 150 desirably selects first route C1 or second route C2 such that main body 101 has a running distance as short as possible when the whole of the environmental map is cleaned along running paths of main body 101.

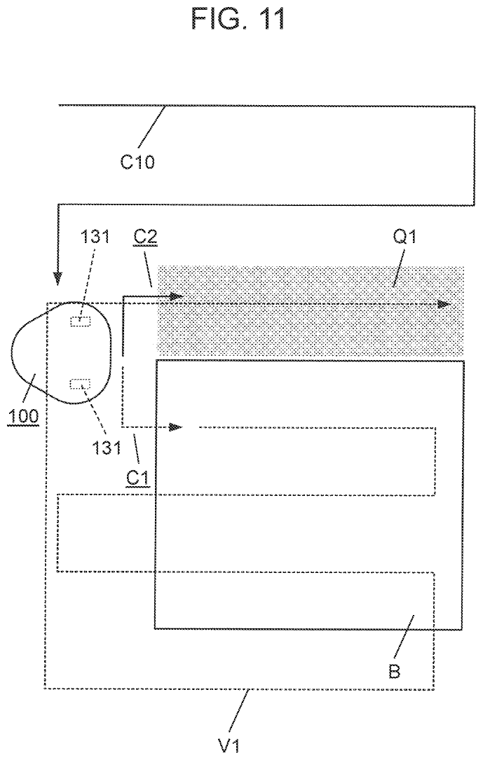

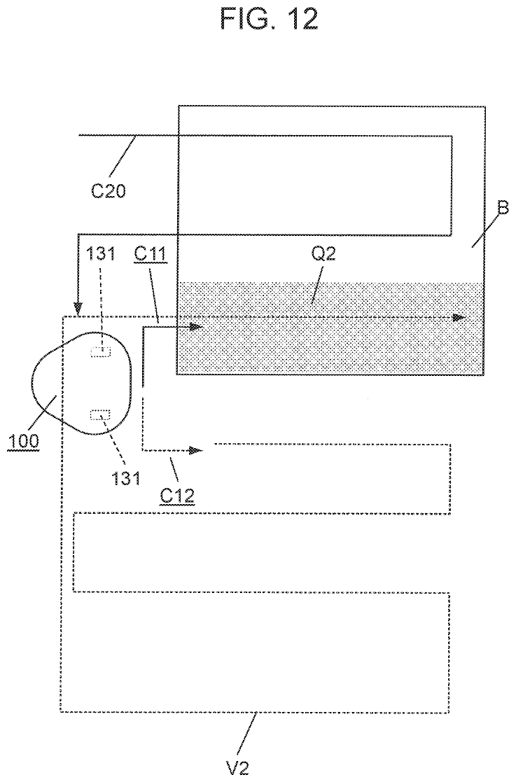

As illustrated in FIGS. 11 and 12, controller 150 may select a route including a path toward previous path C10 before detection of step B from first route C1 and second route C2. Here, previous path C10 is a path in which main body 101 has run during current cleaning, and corresponds to a running path in which main body 101 has run before detection of step B.

First, FIG. 11 is an explanatory diagram illustrating an example in which second route C2 is selected based on previous path C10. In FIG. 11, it is assumed that self-propelled vacuum cleaner 100 has run in previous path C10 before detection of step B.

Here, first route C1 is away from previous path C10. That is, when step B is detected during traveling in previous path C10 and self-propelled vacuum cleaner 100 travels in first route C1, self-propelled vacuum cleaner 100 is to be away from previous path M. This causes an area where no cleaning is performed (uncleaned area illustrated by dot hatching in FIG. 11). In this case, self-propelled vacuum cleaner 100 sweeps and cleans a predetermined area as illustrated in virtual path of FIG. 11, for example, after traveling in first route C1. After that, self-propelled vacuum cleaner 100 finally returns to uncleaned area Q1 and moves to clean uncleaned area Q1. This causes uncleaned area Q1 to be cleaned by making a detour, which is inefficient in terms of time.

In contrast, second route C2 illustrated in FIG. 11 is toward previous path C10. That is, when step B is detected during traveling in previous path C10 and self-propelled vacuum cleaner 100 travels in second route C2, self-propelled vacuum cleaner 100 cleans as sweeping the environmental map after approaching previous path C10. This causes uncleaned area Q1 to be less likely to occur. As a result, more efficient cleaning becomes possible.

Next, FIG. 12 is an explanatory diagram illustrating an example in which first route C11 is selected based on previous path C10. In FIG. 12, it is assumed that self-propelled vacuum cleaner 100 has run in previous path C20 before detection of step B.

Here, second route C12 is away from previous path C20. That is, when step B is detected during traveling in previous path C10 and self-propelled vacuum cleaner 100 travels in second route C12, self-propelled vacuum cleaner 100 is to be away from previous path C20. This causes uncleaned area Q2 to occur. In this case, self-propelled vacuum cleaner 100 sweeps and cleans a predetermined area as illustrated in virtual path V2 of FIG. 12, for example, after traveling in second route C12. After that, self-propelled vacuum cleaner 100 finally returns to uncleaned area Q2 and moves to clean uncleaned area Q2. This causes uncleaned area Q2 to be cleaned by making a detour, which is inefficient in terms of time.

In contrast, first route C11 illustrated in FIG. 12 is toward previous path C20. That is, when step B is detected during traveling in previous path C10 and self-propelled vacuum cleaner 100 travels in first route C11, self-propelled vacuum cleaner 100 approaches previous path C20, and thus uncleaned area Q2 is less likely to occur. Thus, more efficient cleaning becomes possible.

Although the above exemplary embodiment describes an example in which controller 150 controls the moving unit to maintain the current traveling direction when the step detector detects that step B exists in front of each of the pair of wheels 131, the present invention is not limited to this. When the step detector detects that step B exists in front of each of the pair of wheels 131, controller 150 may be configured to change the route. For example, when step B has a thickness thicker than a predetermined value, controller 150 may control the moving unit to cause main body 101 to travel in a path avoiding step B. When the current traveling direction of main body 101 tilts from edge b1 of step B detected by the step detector, controller 150 may control the moving unit to cause main body 101 to enter step B in a changed route including a route that is substantially orthogonal (including orthogonal) to edge b1 of step B. Even in the changed route described above, it is assumed that step B exists in front of each of the pair of wheels 131.

### INDUSTRIAL APPLICABILITY

The present invention is applicable to a self-propelled vacuum cleaner that requires efficient cleaning workability and that is capable of autonomous running.

### REFERENCE MARKS IN THE DRAWINGS

100: self-propelled vacuum cleaner
101: main body
101a: front portion
101b: rear portion
119: collision sensor
130: drive unit (moving unit)
131: wheel
132: arm.
132a: leading end portion
132b: base end portion
133: lifter
134: drive motor
135: angular velocity sensor
136: running motor
137: encoder
138: acceleration sensor
140: cleaning unit
150: controller
171: transmitter
172: receiver
173: obstacle sensor
174: ranging sensor
175: camera
176: floor surface sensor
178: suction port
179: caster
B: step
b1: edge
C11: first route
C10, C20: previous path
C12, C2: second route
c21: path
F: floor surface
L1: broken line
P1, P2: point
Q1, Q2: uncleaned area
V1, V2: virtual path
Y1, Y2, Y3: arrow

1. A self-propelled vacuum cleaner comprising:
a main body including a pair of wheels on left and right sides, the main body moving on a floor surface to clean the floor surface;
a moving unit that is provided on the main body and moves or turns the main body;
a step detector provided on the main body and detecting a step existing around the main body; and
a controller that controls the moving unit based on a detection result of the step detector,
the controller controlling the moving unit to cause the main body to move by selecting a first route on which the step exists in front of each of the pair of wheels, or a second route on which no step exists in front of each of the pair of wheels, when the step detector detects that the step exists only in front of one of the pair of wheels.

2. The self-propelled vacuum cleaner according to claim 1, further comprising a lifter provided on the main body and lifting the main body with respect to the floor surface.

3. The self-propelled vacuum cleaner according to claim 1, wherein the controller selects, from the first route and the second route, a route allowing the moving body to return to a previous path on which the moving body has moved until the step detector detects the step.

4. The self-propelled vacuum cleaner according to claim 1, wherein the controller sets the second route includes a path along an edge of the step.

5. The self-propelled vacuum cleaner according to claim 2, wherein the controller selects, from the first route and the second route, a route allowing the moving body to return to a previous path on which the moving body has moved until the step detector detects the step.

6. The self-propelled vacuum cleaner according to claim 2, wherein the controller sets the second route includes a path along an edge of the step.

7. The self-propelled vacuum cleaner according to claim 3, wherein the controller sets the second route includes a path along an edge of the step.

8. The self-propelled vacuum cleaner according to claim 5, wherein the controller sets the second route includes a path along an edge of the step.
